(19) United States
(12) Patent Application Publication
(10) Pub. No.: US 2013/0169621 A1
(43) Pub. Date: Jul. 4, 2013

(54) METHOD OF CREATING AND TRANSFORMING A FACE MODEL AND RELATED SYSTEM

(71) Applicants: Li Mei, Hangzhou City (CN); Naiyang Lin, Hangzhou City (CN); Jin Wang, Hangzhou City (CN)

(72) Inventors: Li Mei, Hangzhou City (CN); Naiyang Lin, Hangzhou City (CN); Jin Wang, Hangzhou City (CN)

(21) Appl. No.: 13/338,261

(22) Filed: Dec. 28, 2011

(51) Int. Cl. G06T 17/00

(52) U.S. Cl. 345/419

(57) ABSTRACT

An input 2D face image is uploaded from a client device with low computation ability to a web server with high computation ability. The web server is configured to provide a parametric model associated with the transformation of a specific facial attribute according to an input 2D face image received from the client device. The client device may thus perform real-time facial feature transformation efficiently.

### BACKGROUND OF THE INVENTION

1. Field of the Invention

The present invention is related to a method of creating and transforming a face model and a related system, and more particularly, to a method of creating and transforming a face model using an electronic device having an embedded platform and a related system.

2. Description of the Prior Art

There are many techniques for creating a three-dimensional (3D) or two-dimensional (2D) face model of a human face which appears in a photo. Such techniques generally include face detection, face synthesis, and face animation, etc. In certain applications, it is required to change facial attributes of a face mode, such as by morphing an existing 3D face model or warping an existing 2D face model. There are many modelers which allow users to apply aging, feminizing, masculinizing or color changing effects on 2D/3D face models.

The creation or transformation of face models require large amount of computation and is normally implemented on a web server. However, there are many difficulties in efficiently applying these techniques to embedded platforms on mobile or handheld devices due to limited memory and low computation ability.

### SUMMARY OF THE INVENTION

The present invention is related to a system of creating and transforming a face model. The system includes a web server and a client device. The web server includes an image detector configured to analyze an input 2D face image and acquire corresponding 2D facial features; a storage unit for storing a first database which includes a first group of reference 2D face images and a second group of reference 2D face images each associated with a specific facial attribute; and a parameter modeler configured to generate a parametric model by processing the first group of reference 2D face images, the second group of reference 2D face images and the 2D facial features of the input 2D face image; and a client device configured to provide the input 2D face image, receive the parametric model from the web server, and transform the specific facial attribute of the input 2D face image by performing a rendering process on the parametric model.

The present also provides a method of creating and transforming a face model. The method includes uploading an input 2D face image from a client device to a web server; acquiring 2D facial features of the input 2D face image on the web server; providing a first group of reference 2D face images and a second group of reference 2D face images each associated with a specific facial attribute on the web server; generating a parametric model by processing the first group of reference 2D face images, the second group of reference 2D face images and the 2D facial features of the input 2D face image on the web server; and transforming the specific facial attribute of the input 2D face image by performing a rendering process on the parametric model received from the web server.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are functional diagrams illustrating a system for creating and transforming face models according to embodiments of the present invention.

### DETAILED DESCRIPTION

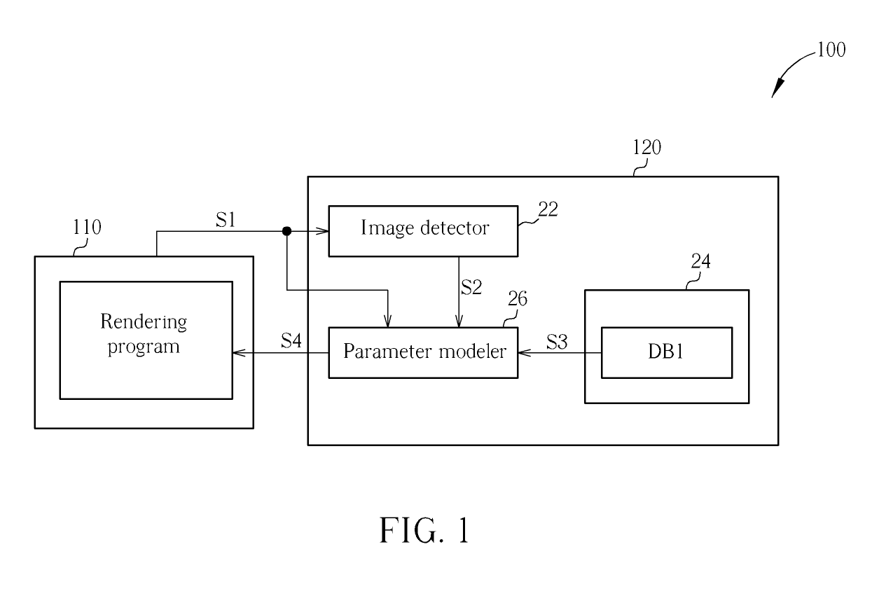

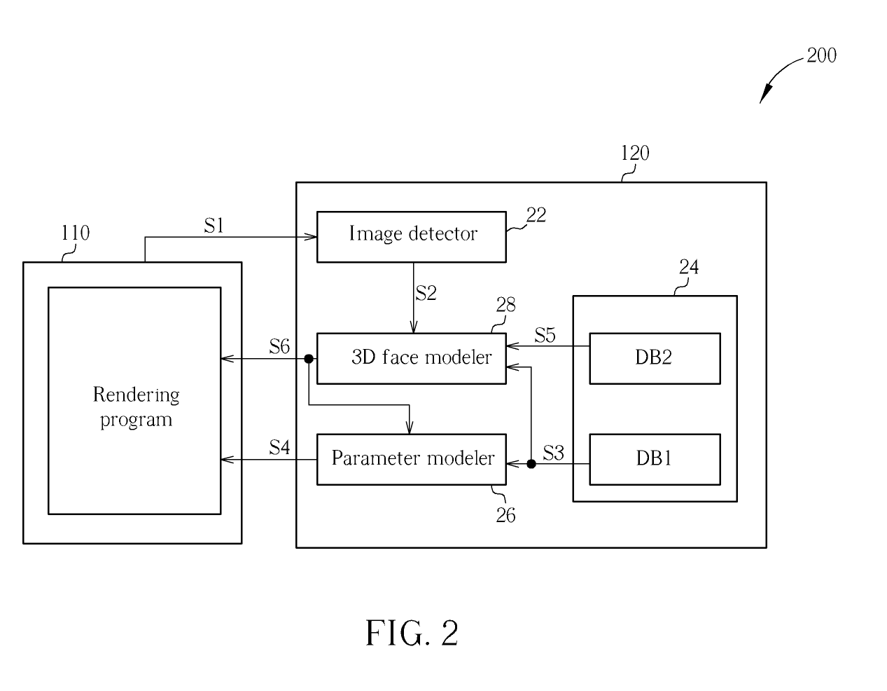

FIG. 1 is a functional diagram illustrating a system 100 for creating and transforming face models according to a first embodiment of the present invention. FIG. 2 is a functional diagram illustrating a system 200 for creating and transforming face models according to a second embodiment of the present invention. The systems 100 and 200 each include a client device 110 and a web server 120. The client device 110 maybe a mobile or handheld device, such as cellular phone, smart phone or tablet computer. The client device 110 may adopt an embedded platform having real-time computing constraints and designed to do one or a few dedicated and/or specific functions.

In the system 100 according to the first embodiment of the present invention, the web server 120 may include an image detector 22, a storage unit 24, and a parameter modeler 26. In the system 200 according to the second embodiment of the present invention, the web server 120 may include an image detector 22, a storage unit 24, a parameter modeler 26, and a 3D face modeler. The operations of each unit in the systems 100 and 200 are illustrated by steps S1-S6, as depicted by the arrows in FIGS. 1 and 2.

In step S1, the client device 110 of the systems 100 and 200 may send an input 2D face image to the web server 120. The input 2D face image maybe a photo captured by a built-in camera of the client device 110 or an image file received from other devices.

In step S2, the image detector 22 of the systems 100 and 200 is configured to analyze the input 2D image received from the client device 110, thereby acquiring corresponding 2D facial features. The 2D facial features may include, but not limited to, color, distinctiveness, size, contour, or inter-distance of the sense organs in the input 2D image.

The storage unit 24 may be any type of memory capable of storing one or more databases, such as a database DB1 in the system 100, or two databases DB1 and DB2 in the system 200.

In the system 100 according to the first embodiment of the present invention, the database DB1 stored in the storage unit 24 of the web server 120 may include multiple groups of reference 2D face images each associated with a specific facial attribute, such as age, gender or skin color. For example, a group of reference 2D face image maybe provided by taking face photos of elder individuals, younger individuals, males, females or different ethnic groups. The database DB1 may be accessed by the parameter modeler 26 in step S3. For age transformation, a group of reference 2D face images obtained from elder individuals and a group of reference 2D face images obtained from younger individuals may be provided in step S3. For gender transformation, a group of reference 2D face images obtained from males and a group of reference 2D face images obtained from females may be provided in step S3.

The parameter modeler 26 of the system 100 is configured to generate a parametric model by processing two groups of reference 2D face images associated with a specific facial attribute provided in step S3 and the 2D facial features provided in step S2. First, the two groups of reference 2D face images may be warped so that the facial points of each reference 2D face image may be aligned with those of the input 2D face image. Then, a source reference image may be acquired by averaging the first group of reference 2D face images and a destination reference image may be acquired by averaging the second group of reference 2D face images. The source reference image and the destination reference image may be analyzed on the points in a neighborhood of the point being synthesized for acquiring a transforming function associated with the specific facial attribute as the parametric model.

In step S4, the web server 120 of the system 100 may then send the parametric model to the client device 110. The client device 110 is installed with a rendering program which allows the user to transform the specific facial attribute of the input 2D face image using the parametric model. For example, the rendering program may cumulate the color/texture difference of the parametric model onto the input 2D face image for age, gender or color transformation.

In the system 200 according to the second embodiment of the present invention, the database DB1 and the database DB2 are stored in the storage unit 24 of the web server 120. The contents of the database DB1 in the system 200 may be similar to those in the system 100. The database DB2 may include a 3D morphable face model which is a multidimensional 3D morphing function based on linear combination of a large number of 3D face scans. Starting from an example set of 3D face models, the 3D morphable face model may be obtained by transforming the shape and texture of the example set into a vector space representation. The database DB2 maybe accessed by the 3D face modeler 28 in step S5.

The 3D face modeler 28 of the system 200 is configured to generate a customized 3D face model by processing the 3D morphable face model provided in step S5 according to the 2D facial features of the input 2D image provided in step S2. Therefore, the customized 3D face model having facial attributes similar to those of the input 2D image may be sent to the client device 110 in step S6.

The parameter modeler 26 of the system 200 is configured to generate the parametric model by processing two groups of reference 2D face images associated with the same facial attribute provided in step S3 and the 3D morphable face model provided in S5. First, the two groups of reference 2D face images may be warped so that the facial points of each reference 2D face image may be aligned with those of the input 2D face image. Then, a source reference image may be acquired by averaging the first group of reference 2D face images and a destination reference image may be acquired by averaging the second group of reference 2D face images. The source reference image and the destination reference image may be analyzed on the points in a neighborhood of the point being synthesized for acquiring a transforming function associated with the specific facial attribute, according to which the 3D morphable face model may be processed for obtaining the parametric model.

First, the two groups of reference 2D face images may be warped so that the facial points of each reference 2D face image may be aligned with those of the input 2D face image. Then, the two groups of reference 2D face images the 3D morphable face model may be analyzed on the points in a neighborhood of the point being synthesized for acquiring an estimated probability distribution, according to which the 3D morphable face model may be processed for obtaining the parametric model associated with the transformation of the specific facial attribute.

In steps S4 and S6, the web server 120 of the system 200 may send the customized 3D face model and the parametric model to the client device 110. The client device 110 is installed with a rendering program which allows the user to perform facial attribute transformation by accumulating the vector associated with the specific facial attribute onto the customized 3D face model according to the parametric model.

In the present invention, a web server with high computation ability is configured to provide a parametric model associated with the transformation of a specific facial attribute according to an input 2D face image received from a client device which adopts an embedded platform. Therefore, the client device with low computation ability may be able to perform facial feature transformation efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system of creating and transforming a face model, comprising:
a web server including:
an image detector configured to analyze an input two-dimensional (2D) face image and acquire corresponding 2D facial features;
a storage unit for storing a first database which includes a first group of reference 2D face images and a second group of reference 2D face images each associated with a specific facial attribute; and
a parameter modeler configured to generate a parametric model by processing the first group of reference 2D face images, the second group of reference 2D face images and the 2D facial features of the input 2D face image; and
a client device configured to provide the input 2D face image, receive the parametric model from the web server, and transform the specific facial attribute of the input 2D face image by performing a rendering process on the parametric model.

2. The system of claim 1, wherein the parameter modeler is further configured to modify the first group of reference 2D face images and the second group of reference 2D face images according to the 2D facial features of the input 2D face image.

3. The system of claim 1, wherein the parameter modeler is further configured to:
generate a source reference image by averaging the first group of reference 2D face images;
generate a destination reference image by averaging the second group of reference 2D face images; and
generate the parametric model which includes a transforming function from the source reference image to the destination reference image.

4. The system of claim 1, wherein the specific facial attribute is associated with an age, a gender or an ethnic group.

5. The system of claim 1, wherein:
the storage unit further stores a second database which includes a three-dimensional (3D) morphable face model;
the web server further comprises a 3D face modeler configured to generate a customized 3D face model by processing the 3D morphable face model according to the 2D facial features of the 2D input face image; and
the parameter modeler is further configured to generate the parametric model by processing the 3D morphable face model according to the first group of reference 2D face images and the second group of reference 2D face images.

6. The system of claim 5, wherein the 3D morphable face model includes a vector representation of a plurality of 3D reference face models .

7. A method of creating and transforming a face model, comprising:
uploading an input 2D face image from a client device to a web server;
acquiring 2D facial features of the input 2D face image on the web server;
providing a first group of reference 2D face images and a second group of reference 2D face images each associated with a specific facial attribute on the web server;
generating a parametric model by processing the first group of reference 2D face images, the second group of reference 2D face images and the 2D facial features of the input 2D face image on the web server; and
transforming the specific facial attribute of the input 2D face image by performing a rendering process on the parametric model received from the web server.

8. The method of claim 7, further comprising:
generating a source reference image by averaging the first group of reference 2D face images;
generating a destination reference image by averaging the second group of reference 2D face images; and
generating the parametric model which includes a transforming function from the source reference image to the destination reference image.

9. The method of claim 8, further comprising:
modifying the source reference image and the destination reference image according to the 2D facial features of the input 2D face image.

10. The method of claim 7, wherein the specific facial attribute is associated with an age, a gender or an ethnic group.

11. The method of claim 7, further comprising
providing a 3D morphable face model on the web server;
generating a customized 3D face model by processing the 3D morphable face model according to the 2D facial features of the 2D input face image; and
generating the parametric model by processing the 3D morphable face model according to the first group of reference 2D face images and the second group of reference 2D face images.

12. The method of claim 11, further comprising
providing a plurality of 3D reference face models;
providing the 3D morphable face model by transforming a shape and a texture of the 3D reference face models into a vector space representation.
